(19) United States
(12) Patent Application Publication
(10) Pub. No.: US 2021/0365346 A1
(43) Pub. Date: Nov. 25, 2021

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Kentaro TAKANO, Kanagawa (JP)

(73) Assignee: FUJIFILM BUSINESS INNOVATION CORP., Tokyo (JP)

(21) Appl. No.: 17/073,480

(22) Filed: Oct. 19, 2020

(30) Foreign Application Priority Data
May 25, 2020 (JP) 2020-090465

(51) Int. Cl. G06F 11/34; G06F 11/30; G16Y 20/20

(52) U.S. Cl. CPC G06F 11/3409; G06F 11/3075; G16Y 20/20; G06F 11/3006; G06F 11/3089

(57) ABSTRACT

An information processing apparatus includes a processor configured to obtain data, obtain calibration information about calibration applied to the data, and provide, to a user, the data in association with a guide which is obtained based on the calibration information or the pattern of the calibration information.

### CROSS-REFERENCE TO RELATED APPLICATIONS

This application is based on and claims priority under 35 USC 119 from Japanese Patent Application No. 2020-090465 filed May 25, 2020.

### BACKGROUND

### (i) Technical Field

The present disclosure relates to an information processing apparatus and a non-transitory computer readable medium.

### (ii) Related Art

There have been attempts to extract useful information by processing a variety of and a large number of pieces of data, which are so-called big data or the like. Big data may be distributed among organizations. Thus, a mechanism of guaranteeing the validity of data, such as certification of a data provision source and assurance of absence of tampering, is required. Some devices in the Internet of Things (IoT), which generates big data, may fail to generate correct data, for example, because sensors are not installed properly or have not been calibrated, or a period has elapsed after calibration. Therefore, a mechanism of assuring accuracy of distributed big data has been also studied (The “calibration” is a process of comparing pieces of data to correct errors.)

For example, Japanese Patent No. 6465012 discloses a data flow control apparatus which performs matching between two types of information: information indicating the specification and the origin of data requested by an application which provides a service by using data; and information indicating the specification and the origin of data provided by each device. Through the matching, a device, which may provide data satisfying both the specification and the origin which are requested by the application, is extracted from the devices.

Japanese Patent No. 5820368 discloses the following measurement control apparatus: sensors detect process variables; a processor processes the process variables to generate a measurement value; the processor calculates a value indicating the reliability of the measurement value on the basis of the operational condition of the measurement control apparatus; an communication interface transmits a diagnosis result based on the measurement value and the value indicating the reliability.

### SUMMARY

Aspects of non-limiting embodiments of the present disclosure relate to a technique that enables a person, to whom data is provided, to grasp the data in addition to information about the calibration which was applied to the data.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to obtain data, obtain calibration information about calibration applied to the data, and provide, to a user, the data in association with a guide which is obtained based on the calibration information or the pattern of the calibration information.

### BRIEF DESCRIPTION OF THE DRAWINGS

Exemplary embodiment of the present disclosure will be described in detail based on the following figures, wherein:

FIG. 1 is a diagram for describing exemplary organizations employing the present exemplary embodiment of the present disclosure;

FIG. 2 is a diagram illustrating the configuration of a system according to the present exemplary embodiment;

FIG. 3 is a diagram illustrating an exemplary configuration of a measuring instrument;

FIG. 4 is a diagram illustrating an exemplary configuration of a server;

FIG. 5 is a diagram illustrating an exemplary measuring device database (DB);

FIG. 6 is a diagram illustrating an exemplary measurement history DB;

FIG. 7 is a diagram illustrating an exemplary configuration of an authentication apparatus;

FIG. 8 is a diagram illustrating an exemplary calibration history DB;

FIGS. 9A and 9B are diagrams illustrating exemplary specifications described in the calibration history DB illustrated in FIG. 8;

FIG. 10 is a diagram illustrating an exemplary configuration of an information processing apparatus;

FIG. 11 is a diagram illustrating an exemplary functional configuration of an authentication apparatus;

FIG. 12 is a diagram illustrating an exemplary functional configuration of an information processing apparatus;

FIG. 13 is a sequence chart for describing a flow of operations of an information processing apparatus;

FIG. 14 is a diagram for describing exemplary organizations employing a modified example of the present disclosure;

FIG. 15 is a diagram illustrating the configuration of a system according to the modified example;

FIG. 16 is a diagram illustrating an exemplary configuration of a transaction management apparatus;

FIG. 17 is a diagram illustrating an exemplary transaction history DB; and

FIG. 18 is a sequence chart for describing a flow of operations of an information processing apparatus according to the modified example.

### DETAILED DESCRIPTION

### Exemplary Embodiment

The Configuration of Organizations

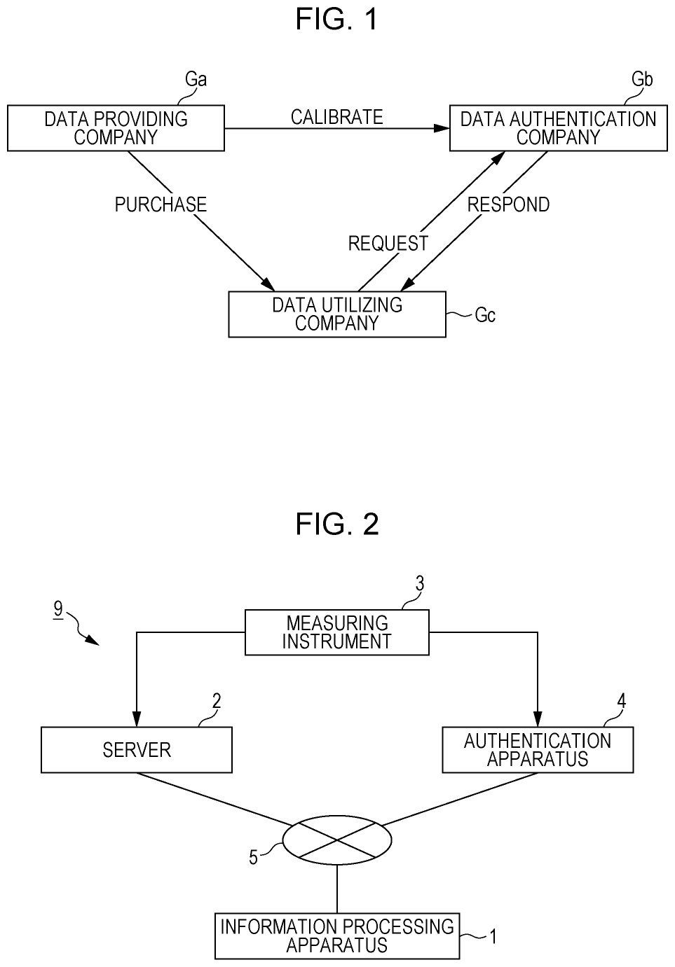

FIG. 1 is a diagram for describing exemplary organizations employing the present exemplary embodiment of the present disclosure. It is assumed that the present exemplary embodiment of the present disclosure is employed by organizations of three businesses, for example, a data providing company Ga, a data authentication company Gb, and a data utilizing company Gc which are illustrated in FIG. 1.

The data providing company Ga, for example, provides measured data. For example, the data providing company Ga has measuring instruments, such as a temperature sensor, a humidity sensor, an acceleration sensor, and a position sensor, and collects, for sale, data measured by the measuring instruments. The data providing company Ga increases the additional value of the data, which is provided by the data providing company Ga, through the accuracy, the amount, the measurement intervals, the measurement target, and the like of the data, with the aim of improving the sales competitiveness. The data is subjected to calibration performed by an independent third party, gaining increased reliability and an increase in the additional value. Therefore, for the data providing company Ga, from which company the calibration and its certification are to be requested is an issue which influences the value of data that is the product of the data providing company Ga.

The data authentication company Gb is an organization which is different from the data providing company Ga and the data utilizing company Gc, and is a so-called third party. The data authentication company Gb calibrates data provided by the data providing company Ga, or verifies a calibration which has been performed. The data authentication company Gb issues a certificate which is granted to certificate a calibration of data according to a determined standard, such as ISO/IEC. The data authentication company Gb increases the additional value of the calibration service, which is provided by the data authentication company Gb, through the types or the accuracy of calibration, the types of issued certificates, or the like.

The data utilizing company Gc is a company or the like which purchases, for use, data from the data providing company Ga. For example, the data utilizing company Gc determines a detailed climate distribution from positional information, temperature information, humidity information, and the like which are measured by using measuring instruments attached to multiple vehicles and which are obtained from the data providing company Ga. Then, the data utilizing company Gc predicts changes in the climate distribution, and provides, to users, information about climate, information about a traffic congestion state, or other information. The amount and accuracy of purchased data influence the value of a service, which is provided by the data utilizing company Gc. Therefore, for the data utilizing company Gc, the decision about from which organization the data is to be purchased, how much the amount of the data that is to be purchased is, and how high the quality of the data is influences the value of the service of the data utilizing company Gc. The quality of data, which is to be purchased, is influenced by the type, the quality, the frequency, and the like of the calibration performed on the data.

The present disclosure provides an environment in which each of the data providing company Ga, the data authentication company Gb, and the data utilizing company Gc selects the other companies without restriction.

The Overall Configuration of a System

FIG. 2 is a diagram illustrating the configuration of a system 9 according to the present exemplary embodiment. The system 9 includes an information processing apparatus 1, a server 2, measuring instruments 3, an authentication apparatus 4, and a communication line 5.

The measuring instruments 3 are, for example, owned by the data providing company Ga. The data providing company Ga owns a relatively large number of measuring instruments 3, for example, hundreds to hundreds of millions of instruments. Each measuring instrument 3 measures one or more pieces of data, and outputs the data to the server 2. When each measuring instrument 3 receives data calibration, the measuring instrument 3 outputs information about the calibration to the authentication apparatus 4.

The server 2, which is an apparatus owned by the data providing company Ga, collects pieces of data measured by the measuring instruments 3. The collected data is sold to users. The server 2 presents the types, the amounts, the measurement periods, and the like of pieces of data in response to a user's request, and supplies data, which has been selected by the user, for remuneration. The data collected by the server 2 from the measuring instruments 3 is provided to the information processing apparatus 1 owned by the user who has purchased the data.

The information processing apparatus 1 is owned by the data utilizing company Gc, and is, for example, a computer. The information processing apparatus 1 uses data obtained from the server 2 for remuneration. The information processing apparatus 1 makes various inferences and predictions by using the obtained data, for example, applied to machine learning. The information processing apparatus 1 requests information about the calibration, which was performed on the data, from the authentication apparatus 4 before or after purchase of the data, and obtains the information. Information about calibration on data is used in evaluation of the data.

The authentication apparatus 4 is owned by the data authentication company Gb, and collects information about calibration which was performed on the measuring instruments 3. The authentication apparatus 4 provides information about calibration which was performed on data specified in accordance with a user's request. The authentication apparatus 4 outputs, to the information processing apparatus 1, the information about calibration.

The communication line 5, which is, for example, the Internet, connects the information processing apparatus 1, the server 2, and the authentication apparatus 4 to each other communicatively. The communication line 5 may include a local area network (LAN), a wide area network (WAN), a public switched telephone networks (PSTN), and an integrated services digital network (ISDN).

The Configuration of a Measuring Instrument

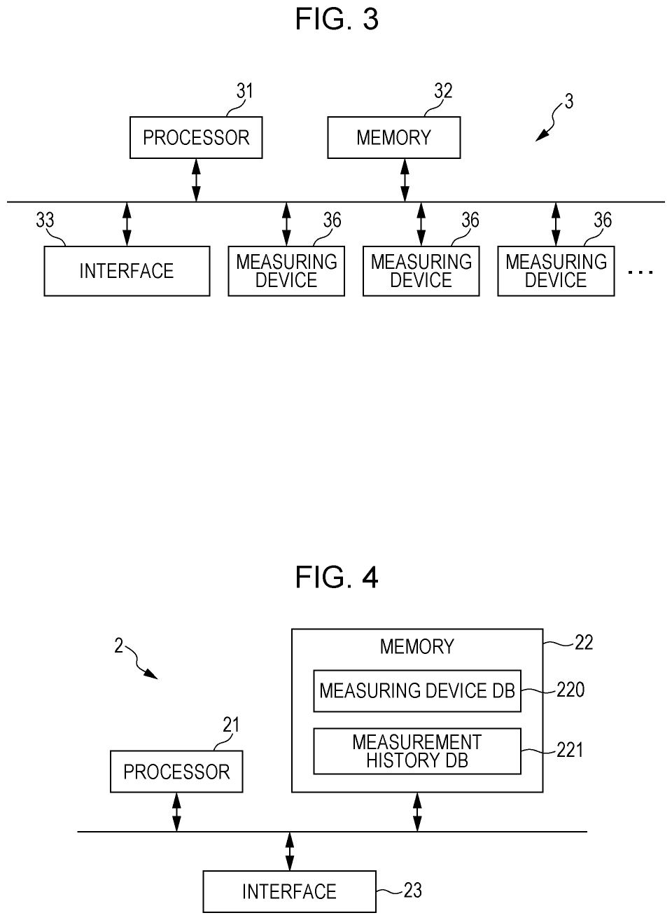

FIG. 3 is a diagram illustrating an exemplary configuration of a measuring instrument 3. The measuring instrument 3 illustrated in FIG. 3 includes a processor 31, a memory 32, an interface 33, and measuring devices 36. These configurations are connected to each other communicatively.

The processor 31 reads, for execution, computer programs (hereinafter simply referred to as programs) which are stored in the memory 32, thus controlling the units of the measuring instrument 3. The processor 31 is, for example, a central processing unit (CPU). The processor 31 may use a quartz oscillator, which is included therein, to obtain time information indicating the current time.

The memory 32 is a storage unit which stores an operating system, which is read by the processor 31, various programs and data, and the like. The memory 32 includes a random access memory (RAM) and a read only memory (ROM). The memory 32 may include a solid state drive and a hard disk drive.

Each measuring device 36 detects events around the measuring device 36, or measures physical quantities around the measuring device 36. One or more measuring devices 36 are provided in the measuring instrument 3. Examples of data measured by the measuring devices 36 include the position, the acceleration, the angular velocity, the temperature, the humidity, the luminous intensity, and the magnetism. The measuring devices 36 may be attached to a living being such as a human being to measure its biological information, such as the pulse, the breath sound, the blood oxygen level, and the sweat rate.

If any of the measuring devices 36 is a positioning device using the global navigation satellite system (GNSS), the processor 31 may obtain the time information on the basis of information included in radio waves received from multiple satellites. The measuring instrument 3 may regularly calibrate the time information, which is indicated by the quartz oscillator, by using the information in the radio waves received from the satellites.

The interface 33 transmits, to the server 2, data, which is measured by the measuring devices 36, in a format according to the so-called low power, wide area (LPWA) standard, such as LTE Cat-1, LTE Cat-M, or IEEE802.11ah. The interface 33 uses LPWA to perform wireless communication over a relatively-wide area with a relatively-low power consumption.

The processor 31 specifies time information (referred to as measurement time information) indicating the times at which the measuring devices 36 measure data, and transmits the data in association with the specified time information to the server 2 through the interface 33.

The processor 31 stores, in the memory 32, the time at which each measuring device 36 starts to operate, and the time at which the measuring device 36 stops temporarily. The processor 31 calculates the operating time of the measuring device 36 from these times. The processor 31 transmits information, indicating the calculated operating times, at a determined timing to the server 2 through the interface 33.

The data may be transmitted at each measurement, or may be transmitted every time a predetermined number of pieces of data are stored in the memory 32. The measuring instrument 3 may accumulate data, which is measured by the measuring devices 36, in the memory 32 and may regularly read the accumulated data and transmit the read data to the server 2.

The interface 33 transmits, to the authentication apparatus 4, information about calibration on data. The calibration on data is performed manually or by the processor 31. When calibration is performed manually, the processor 31 excludes the calibration time from the operating time. Then, the processor 31 specifies the information about calibration, such as the type of calibration which was performed, the device used in the calibration, and the like, and transmits the specified information to the authentication apparatus 4 through the interface 33.

The interface 33 may, for example, transmit the data in a format other than the format according to the LPWA standard. For example, the interface 33 may be such a type that the interface 33 has a socket or the like to which a communication cable or the like is inserted; when a communication cable or the like is inserted to the socket, information is exchanged through wire. In this case, for example, the owner of the measuring instrument 3 connects, to the measuring instrument 3 which has been recovered, a first end of the communication cable or the like whose second end is connected to the server 2. Then, data and the like accumulated in the memory 32 are collected through the interface 33, and are transmitted to the server 2.

The Configuration of the Server

FIG. 4 is a diagram illustrating an exemplary configuration of the server 2. The server 2 illustrated in FIG. 4 includes a processor 21, a memory 22, and an interface 23. These configurations are connected to each other, for example, through a bus communicatively.

The processor 21 reads, for execution, programs stored in the memory 22, thus controlling the units of the server 2. The processor 21 is, for example, a CPU.

The interface 23 is a communication line connecting the server 2 to other apparatuses with or without wires communicatively. As illustrated in FIG. 1, the interface 23 illustrated in FIG. 4 communicates with the information processing apparatus 1 and the authentication apparatus 4 through the communication line 5. The interface 23 obtains data from the measuring instruments 3 by using LPWA described above.

The memory 22 is a storage unit storing an operating system, which is read by the processor 21, various programs and data, and the like. The memory 22 includes a RAM and a ROM. The memory 22 may include a solid state drive and a hard disk drive. The memory 22 stores a measuring device DB 220 and a measurement history DB 221.

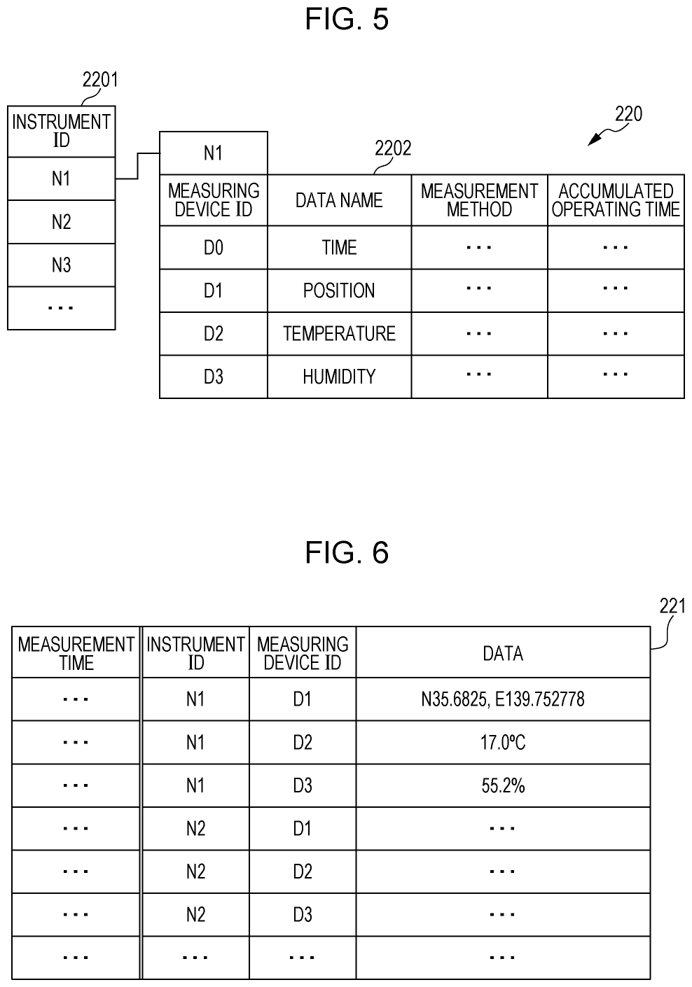

FIG. 5 is a diagram illustrating an exemplary measuring device DB 220. The measuring device DB 220 is a database storing information about the measuring devices 36 which measure data. The measuring device DB 220 includes an instrument ID list 2201 and a measuring device table 2202.

The instrument ID list 2201 is a list of the instrument IDs. These instrument IDs are identification information for identifying the measuring instruments 3 which transmit data to the server 2.

The measuring device table 2202 is provided in association with the corresponding instrument ID listed in the instrument ID list 2201, and stores information about the measuring devices 36 included in the measuring instrument 3 indicated by the corresponding instrument ID.

The measuring device table 2202 illustrated in FIG. 5 has items of the measuring device ID, the data name, the measurement method, and the accumulated operating time. The measuring device ID is identification information for identifying a measuring device 36 described above. The data name is a symbol such as a string indicating the name of data measured by the measuring device 36 identified by the corresponding measuring device ID. The measurement method is information indicating the data measurement method employed by the measuring device 36. The accumulated operating time is information in which the operating times of the measuring device 36 are accumulated.

FIG. 6 is a diagram illustrating an exemplary measurement history DB 221. The measurement history DB 221 stores the histories of pieces of data obtained by the server 2 from the measuring instruments 3. The measurement history DB 221 illustrated in FIG. 6 has items of the measurement time, the instrument ID, the measuring device ID, and the data.

In the measurement history DB 221 illustrated in FIG. 6, the data item stores obtained data itself. The measurement time item stores a time (referred to as a measurement time) at which the corresponding data was measured. The measurement time is indicated by measurement time information transmitted with the obtained data. The instrument ID item stores the instrument ID of the measuring instrument 3 which transmitted the data. The measuring device ID item stores the measuring device ID of the measuring device 36 which is included in the measuring instrument 3 and which measured the corresponding data.

The Configuration of the Authentication Apparatus

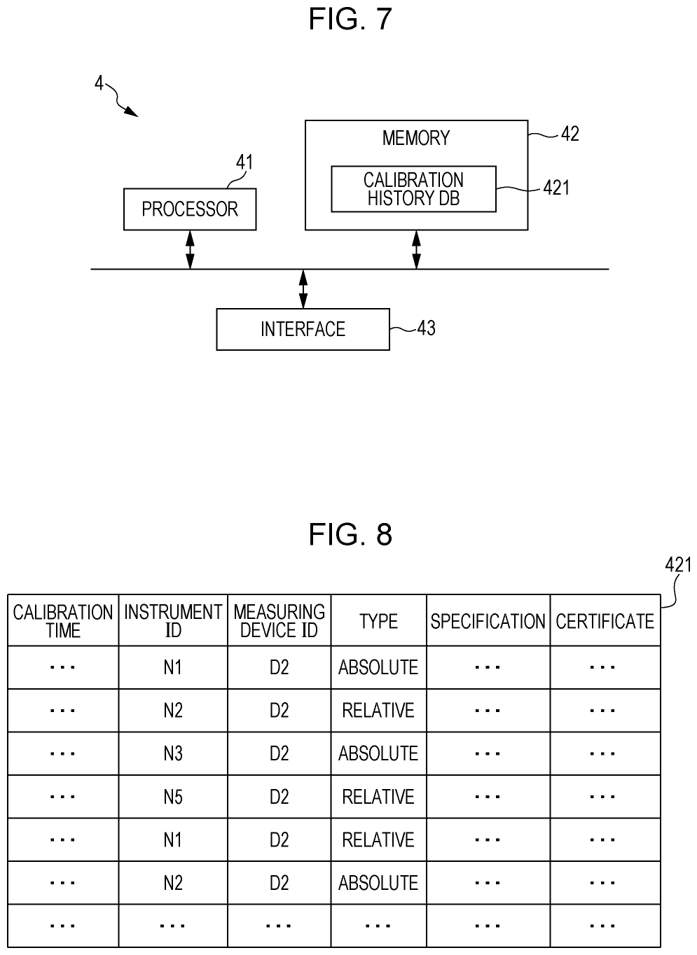

FIG. 7 is a diagram illustrating an exemplary configuration of the authentication apparatus 4. The authentication apparatus 4 illustrated in FIG. 7 includes a processor 41, a memory 42, and an interface 43. These configurations are connected to each other, for example, through a bus communicatively.

The processor 41 reads, for execution, programs stored in the memory 42, thus controlling the units of the authentication apparatus 4. The processor 41 is, for example, a CPU.

The interface 43 is a communication line connecting the authentication apparatus 4 to other apparatuses with or without wires communicatively. As illustrated in FIG. 1, the interface 43 illustrated in FIG. 7 communicates with the information processing apparatus 1 and the server 2 through the communication line 5. The interface 43 uses LPWA described above to obtain the information about calibration on data from the measuring instruments 3.

The memory 42 is a storage unit storing an operating system, which is read by the processor 41, various programs and data, and the like. The memory 42 includes a RAM and a ROM. The memory 42 may include a solid state drive and a hard disk drive. The memory 42 stores a calibration history DB 421.

FIG. 8 is a diagram illustrating an exemplary calibration history DB 421. The calibration history DB 421 stores, as a history (referred to as a calibration history), information which describes calibration on data and which is obtained by the authentication apparatus 4 from the measuring instruments 3. The calibration history DB 421 illustrated in FIG. 8 has items of the calibration time, the instrument ID, the measuring device ID, the type, the specification, and the certificate.

In the calibration history DB 421 illustrated in FIG. 8, the calibration time indicates a time at which calibration was applied to data measured by a measuring device 36. The measuring device ID is identification information of the measuring device 36 for which the calibration was performed. The instrument ID is identification information of the measuring instrument 3 including the measuring device 36. The type illustrated in FIG. 8 indicates the type of the calibration which was performed. As the type, there are at least two types, “absolute” and “relative”. In this field, “absolute” indicates absolute calibration, and “relative” indicates relative calibration.

The absolute calibration is calibration using a determined reference. For example, when a measuring device 36 that is to be calibrated is a thermometer, the absolute calibration is a method in which the measuring device 36 is made to measure a target, such as ice water, whose temperature matches an absolute reference and in which the measurement value is modified. In addition, the absolute calibration may be performed in such a manner that a measuring device 36 is made to measure a common target measured by a reference measuring device which is a measuring device that has been calibrated already, and that these measurement values are checked against each other. The absolute calibration is also called ground calibration, matching calibration, or the like. Herein, the absolute calibration is also referred to as first calibration.

The relative calibration is calibration using the relationship between measuring devices 36 which measure data. The relative calibration is also called blind calibration. The relative calibration, which is not such calibration that a measurement value is checked against the absolute reference, is performed, for example, in accordance with a difference or the like from data measured by nearby measuring devices 36.

When measuring devices 36 are to be calibrated in a chain manner, a measuring device 36 which has been calibrated by using the absolute reference may be used in calibration of a different measuring device 36. Further, the different measuring device 36 may be used in calibration of a second different measuring device 36. The number of sets of the reference, which is used in calibration, and a measuring device 36, which is to be calibrated, is called a hop count. Calibration, in which a determined number of hops to the absolute reference are allowed to be made, is called semi-blind calibration. The semi-blind calibration is also calibration using the relationship between measuring devices 36 that are to be calibrated, and is thus a type of relative calibration.

Further, in the relative calibration, the measurement target of a measuring device 36 that is to be calibrated may be different from that of a different measuring device 36 used in the calibration. For example, to calibrate a measuring device 36 that is a thermometer, a hygrometer and an illuminometer, which are disposed at positions determined relative to the thermometer, may be used. The method of calibrating any of groups formed of different types of sensors is called grouping calibration. The grouping calibration is also calibration using the relationship between measuring devices 36, and is thus a type of relative calibration. Hereinafter, the relative calibration is also referred to as second calibration.

That is, calibration stored in the calibration history DB 421 is exemplary calibration in which there are at least two types: the first calibration using a determined reference; and the second calibration using the relationship between measuring devices which measured data.

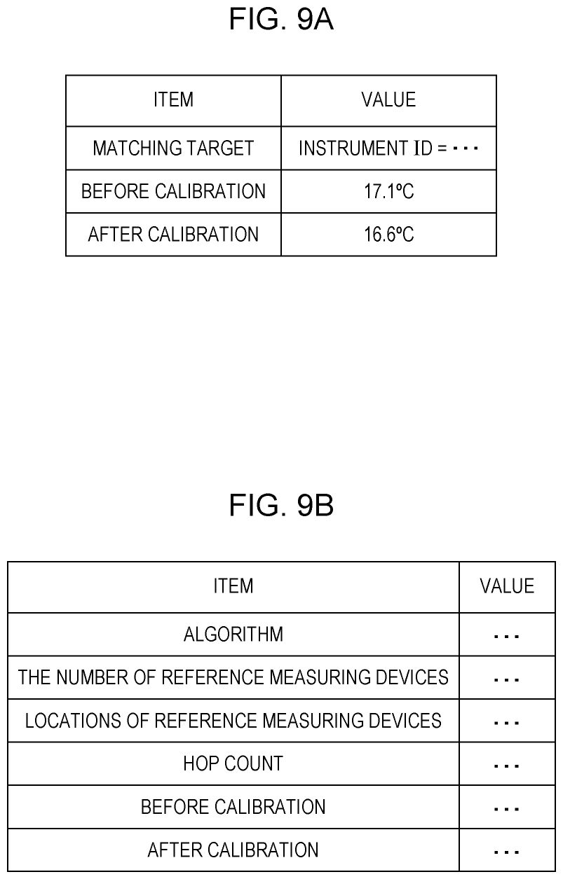

In the calibration history DB 421 illustrated in FIG. 8, the specification indicates detailed content of the calibration. FIGS. 9A and 9B are diagrams illustrating exemplary specifications described in the calibration history DB 421 illustrated in FIG. 8. When the type of calibration is the absolute calibration, the field of the specification in the calibration history DB 421 stores, for example, sets of an item and a value which are illustrated in FIG. 9A. Among the items illustrated in FIG. 9A, “matching target” means the target which serves as the absolute reference, and “instrument ID= . . . ” is stored as the corresponding value. In this case, this means that the measuring instrument 3 identified by using the instrument ID is a target which serves as the reference which has been calibrated. Alternatively, as the value of the matching target, the name of the measurement target itself which serves as the reference, such as “ice water”, may be stored. In the specification, as illustrated in FIG. 9A, sets of an item and a value which store how the data was changed before and after the calibration may be present.

When the type of calibration is the relative calibration, the field of the specification in the calibration history DB 421 stores, for example, sets of an item and a value which are illustrated in FIG. 9B. Among the items illustrated in FIG. 9B, the item, “algorithm”, stores information indicating the algorithm of a program executed by the processor 31 in the relative calibration. The item, “the number of reference measuring devices”, stores the number of measuring devices 36 which were referred to in the relative calibration. The item, “locations of reference measuring devices”, stores relative positions between a measuring device 36, which was referred to in the relative calibration, and a measuring device 36 to which the relative calibration was applied.

When the type of calibration is the relative calibration, the field of the specification in the calibration history DB 421 may store at least one of the following items: the algorithm; the number of reference measuring devices; the locations of reference measuring devices. That is, the information about relative calibration stored in the calibration history DB 421 is exemplary second information about calibration which includes information corresponding to at least any of the following information: the algorithm using the relationship between measuring devices; the number of measuring devices; the locations of measuring devices.

The item, “hop count”, stores the hop count to the absolute reference when the relative calibration is performed in a chain manner as described above. Also in the specification in the relative calibration, as illustrated in FIG. 9B, sets of an item and a value for storing how the data was changed before and after the calibration may be present.

In the calibration history DB 421 illustrated in FIG. 8, the field of the certificate stores data of a certificate indicating certification of the fact that, for example, the corresponding calibration satisfies a reference determined by a standardization organization or the like. Other than certification for the absolute calibration, a certificate may be issued for the relative calibration, which is performed as an operation, by applying for a review that the calibration was performed so that the reference is satisfied.

The Configuration of the Information Processing Apparatus

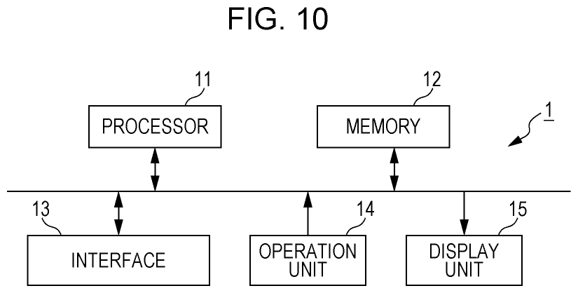

FIG. 10 is a diagram illustrating an exemplary configuration of the information processing apparatus 1. The information processing apparatus 1 illustrated in FIG. 10 includes a processor 11, a memory 12, an interface 13, an operation unit 14, and a display unit 15. These configurations are connected to each other, for example, through a bus communicatively.

The processor 11 reads, for execution, programs, which are stored in the memory 12, thus controlling the units of the information processing apparatus 1. The processor 11 is, for example, a CPU.

The memory 12 is a storage unit which stores an operating system, which is read by the processor 11, various programs and data, and the like. The memory 12 includes a RAM and a ROM. The memory 12 may include a solid state drive and a hard disk drive.

The interface 13 is a communication line which connects the information processing apparatus 1 to other apparatuses with or without wires communicatively. As illustrated in FIG. 1, the interface 13 illustrated in FIG. 10 connects the information processing apparatus 1 to the server 2 and the authentication apparatus 4 through the communication line 5.

The operation unit 14 includes operators, such as operation buttons, a keyboard, a touch panel, and a mouse, for transmitting various instructions, and receives operations and transmits, to the processor 11, signals according to the operation content.

The display unit 15, which has a display screen such as a liquid-crystal display, displays images under control of the processor 11. A transparent touch panel of the operation unit 14 may overlie the display screen. The information processing apparatus 1 does not necessarily include the operation unit 14 and the display unit 15. The information processing apparatus 1 may be operated from an external apparatus through the interface 13, or may present information on an external apparatus.

The Functional Configuration of the Authentication Apparatus

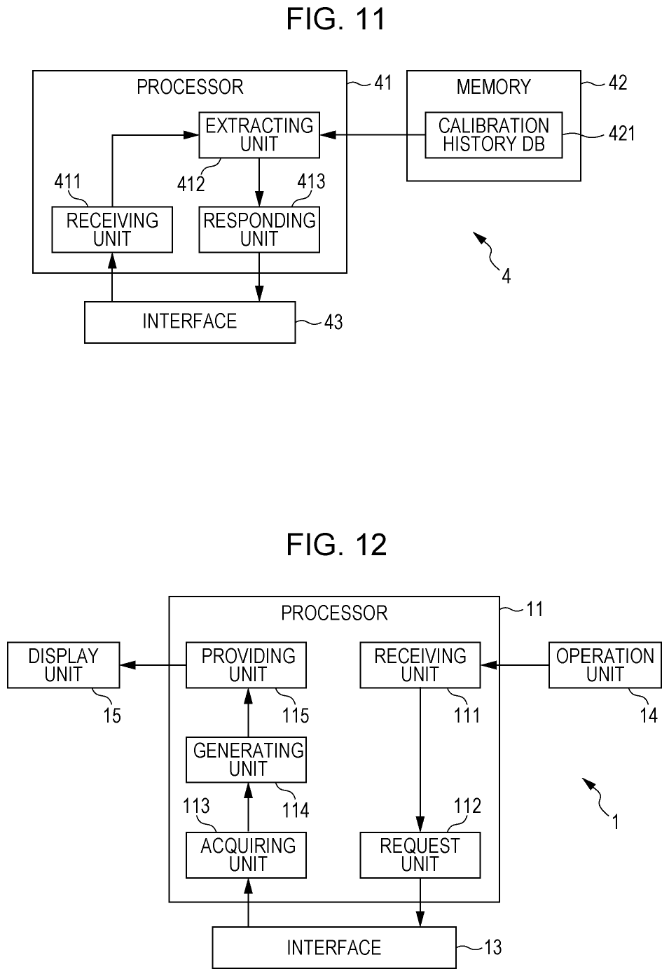

FIG. 11 is a diagram illustrating an exemplary functional configuration of the authentication apparatus 4. The processor 41 of the authentication apparatus 4 executes programs stored in the memory 42, thus functioning as a receiving unit 411, an extracting unit 412, and a responding unit 413.

The receiving unit 411 receives, from the information processing apparatus 1 through the communication line 5 and the interface 43, a request for information about the calibration which was applied to specified data. For example, the receiving unit 411 receives, from the information processing apparatus 1, a request including measurement time information of the specified data.

The extracting unit 412 extracts, from the calibration history DB 421, information about the calibration which was performed before the measurement time indicated by the measurement time information received by the receiving unit 411. At that time, the extracting unit 412 may extract information about the calibration starting from the measurement time, which is indicated by the received measurement time information, and going back to the latest absolute calibration.

The responding unit 413 transmits, to the information processing apparatus 1 through the communication line 5 and the interface 43, information, which is extracted by the extracting unit 412, as a response to a request received by the receiving unit 411.

The Functional Configuration of the Information Processing Apparatus

FIG. 12 is a diagram illustrating an exemplary functional configuration of the information processing apparatus 1. The processor 11 of the information processing apparatus 1 executes programs, which are stored in the memory 12, thus functioning as a receiving unit 111, a request unit 112, an acquiring unit 113, a generating unit 114, and a providing unit 115.

The receiving unit 111 receives operations performed on the operation unit 14 by a user of the information processing apparatus 1. The request unit 112 transmits, to the authentication apparatus 4 through the interface 13, requests in accordance with the operations received by the receiving unit 111.

The acquiring unit 113 acquires responses to the requests through the interface 13. For example, when the request unit 112 requests a data purchase screen from the server 2, the acquiring unit 113 acquires, from the server 2, information about the purchase screen which is a response to the request. On the purchase screen, for example, pieces of data, which are purchasable products, are displayed in association with their measurement locations, their measurement targets, their measurement times, their measurement periods, and the like.

For example, when the request unit 112 requests purchased data from the server 2, the acquiring unit 113 acquires the data. For example, when the request unit 112 specifies the measurement time of data specified on the purchase screen, and requests, from the authentication apparatus 4, information about calibration, which was applied to the data, the acquiring unit 113 acquires the information about calibration from the authentication apparatus 4 through the interface 13. Therefore, the processor 11 functioning as the acquiring unit 113 is an exemplary processor which acquires data, and which acquires information about calibration which was applied to the data.

The generating unit 114 uses the information, which is acquired by the acquiring unit 113 and which describes calibration that was applied to data, to generate a guide for the data. The guide is, for example, an evaluation result obtained through evaluation on data acquired by the acquiring unit 113, by using an evaluation method determined in accordance with the calibration indicated by the acquired information. The generating unit 114 may reflect the accumulated operating time of the measuring device 36, which measured the data, to the evaluation. In this case, the information processing apparatus 1 may obtain, from the server 2, information indicating the accumulated operating time of the target data.

That is, when, in accordance with an operation received by the receiving unit 111, the request unit 112 specifies the measurement time of data and requests information about calibration which was applied to the data, the acquiring unit 113 acquires, in accordance with the request, information indicating, for example, the specification of the latest absolute calibration (that is, the first calibration) which was performed on the data, the specification of the relative calibration (that is, the second calibration) which was performed after the absolute calibration, the count of relative calibrations, whether or not certificates have been attached to the relative calibrations, and the content and the ranks of the certificates, as information about calibration which was applied to the data.

In this case, the obtained “information about calibration” includes information (referred to as type information) about the type of applied calibration. That is, the “information about calibration” acquired by the acquiring unit 113 is exemplary information including type information indicating the type of calibration.

The generating unit 114 evaluates the reliability of the data, to which the calibration was applied, from the calibration types, the specifications, the count, the certificates, and the like which are obtained, and generates an evaluation result as a guide for the data. In this case, the guide generated by the generating unit 114 is an exemplary guide including an evaluation result obtained though evaluation on data by using an evaluation method determined in accordance with the calibration indicated by the information about calibration which was applied to the specified data.

The providing unit 115 provides the guide, which is generated by the generating unit 114, to the user in association with the data. The providing unit 115 illustrated in FIG. 12 displays an image, in which the guide is associated with the data, on the display unit 15, and provides the guide and the data to the user. Therefore, the processor 11 functioning as the generating unit 114 and the providing unit 115 is an exemplary processor which provides data to a user in association with a guide in accordance with the information about calibration on the data.

The processor 11 functioning as the acquiring unit 113 in this case is an exemplary processor which obtains the measurement time information, which indicates the time at which data was measured, in association with the data, and which uses the measurement time information to obtain information about calibration on the data which was measured at the time indicated by the measurement time information.

The acquiring unit 113 may acquire calibration time information indicating the time (that is, the calibration time) at which the calibration was applied to the data, along with the information about calibration. In this case, the generating unit 114 may generate a guide for data by using the measurement time information, which indicates the measurement time at which the data was measured, and the calibration time information which indicates the calibration time at which the calibration was applied to the data.

Therefore, the processor 11 functioning as the acquiring unit 113 in this case is an exemplary processor which obtains the information about calibration along with the calibration time information indicating the time at which the calibration indicated by the information about calibration was applied to the data. The processor 11 functioning as the generating unit 114 and the providing unit 115 in this case is an exemplary processor which uses the measurement time information and the calibration time information to provide any piece of data in association with a guide.

The Operations of the Information Processing Apparatus

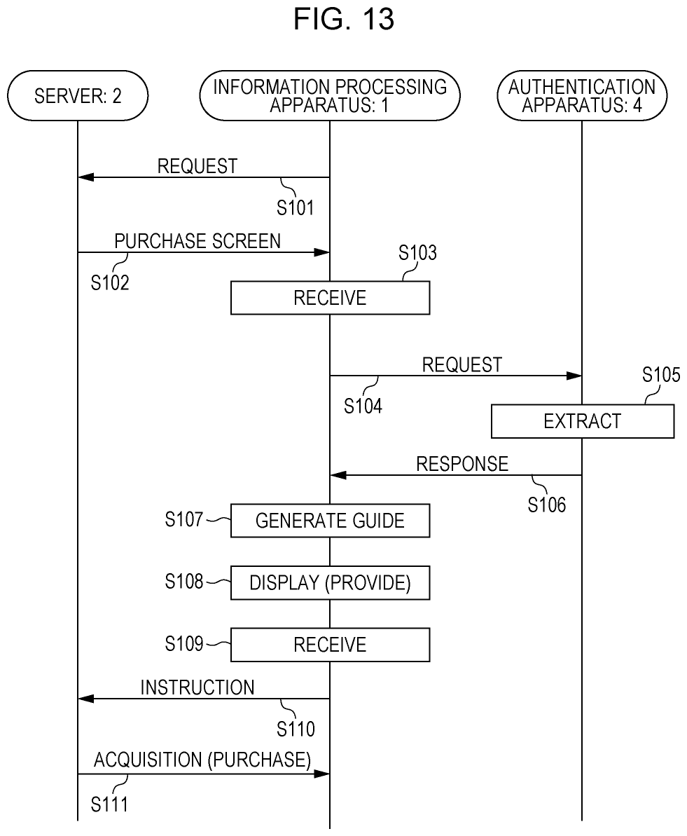

FIG. 13 is a sequence chart for describing the flow of operations of the information processing apparatus 1. As illustrated in FIG. 13, when the information processing apparatus 1 requests the data purchase screen from the server 2 (step S101), the server 2 provides, in response to the request, screen information, which indicates the purchase screen, to the information processing apparatus 1 (step S102). The purchase screen is a Web page screen described in a markup language such as Hypertext Markup Language (HTML), and includes various objects, such as text forms and buttons for receiving operations for purchase.

A user of the information processing apparatus 1 views the purchase screen provided from the server 2. On the purchase screen, pieces of data are listed as products along with the times at which the pieces of data were measured. The user selects, from the purchase screen, data on which the user wants to obtain information about applied calibration, and presses a button for requesting information about the calibration which was applied to the selected data. When the information processing apparatus 1 receives the operation (step S103), the information processing apparatus 1 requests, from the authentication apparatus 4, information about the calibration, which was applied to the data, by specifying the measurement time information of the data specified by the operation (step S104).

The authentication apparatus 4 extracts a calibration history, which complies with the request, from the calibration history DB 421 in accordance with the request received from the information processing apparatus 1 (step S105), and transmits, to the information processing apparatus 1, information about each record of the extracted calibration history, thus responding to the request (step S106).

The information processing apparatus 1 generates a guide in accordance with the information obtained from the authentication apparatus 4 (step S107), and displays the generated guide on the display unit 15 in association with the data specified by the user, thus providing the guide to the user (step S108).

The user of the information processing apparatus 1 who views the displayed guide selects data that is to be purchased. The information processing apparatus 1 receives the operation (step S109), and instructs the server 2 to fulfil a purchase request on the selected data (step S110). The server 2 provides the data, on which the purchase instruction has been transmitted, to the information processing apparatus 1. Thus, the information processing apparatus 1 obtains the data on which the purchase instruction has been transmitted (step S111).

Through the operations described above, the data is guided in association with information about calibration which was applied to the data. Thus, a user, who is to purchase the data, checks the quality, the frequency, and the like of the calibration, evaluates the reliability of the data, and obtains help for selection of data which fits the user's purpose. That is, according to the present exemplary embodiment of the present disclosure, a user, to whom data is provided, grasps the data along with information about calibration which was applied to the data.

### MODIFIED EXAMPLES

The present exemplary embodiment is described above. The present exemplary embodiment may be changed as follows. In addition, the modified examples described below may be combined with each other.

<1>

In the present exemplary embodiment described above, the information processing apparatus 1, the server 2, and the authentication apparatus 4 have the processor 11, the processor 21, and the processor 41, respectively, which are formed of CPUs. The controllers which control the devices may have another configuration. For example, the devices may have various processors and the like in addition to CPUs.

In the embodiment above, the term “processor” refers to hardware in a broad sense. Examples of the processor includes general processors (e.g., CPU), dedicated processors (e.g., GPU: Graphics Processing Unit, ASIC: Application Specific Integrated Circuit, FPGA: Field Programmable Gate Array, and programmable logic device).

<2>

In the embodiment above, the term “processor” is broad enough to encompass one processor or plural processors in collaboration which are located physically apart from each other but may work cooperatively.

The order of operations of the processor is not limited to one described in the embodiment above, and may be changed.

<3>

In the present exemplary embodiment described above, the processor 11 obtains information about calibration, which was applied to data, from the authentication apparatus 4. Alternatively, the processor 11 may obtain the information from the server 2 which is a provision source of data. In this case, the processor 11 may obtain information about calibration, which was applied to data, in a form different from that of the data. That is, the processor 11 according to the modified example is an exemplary processor which obtains, from the provision source which provides data, information which describes calibration on the data and which is presented in a form different from that of the data.

In the present exemplary embodiment described above, before the information processing apparatus 1 obtains data from the server 2, the information processing apparatus 1 obtains information about calibration, which was applied to the data, as information for making a decision for purchase. Alternatively, the information processing apparatus 1 may obtain, from the server 2, information about calibration which was applied on data that has been purchased. In this case, for example, the processor 11 may request information about calibration from the authentication apparatus 4 by specifying measurement time information of the obtained data.

<4>

In the present exemplary embodiment described above, a guide provided to the information processing apparatus 1 does not include information in accordance with past transactions, but may include information generated in accordance with past transactions of data.

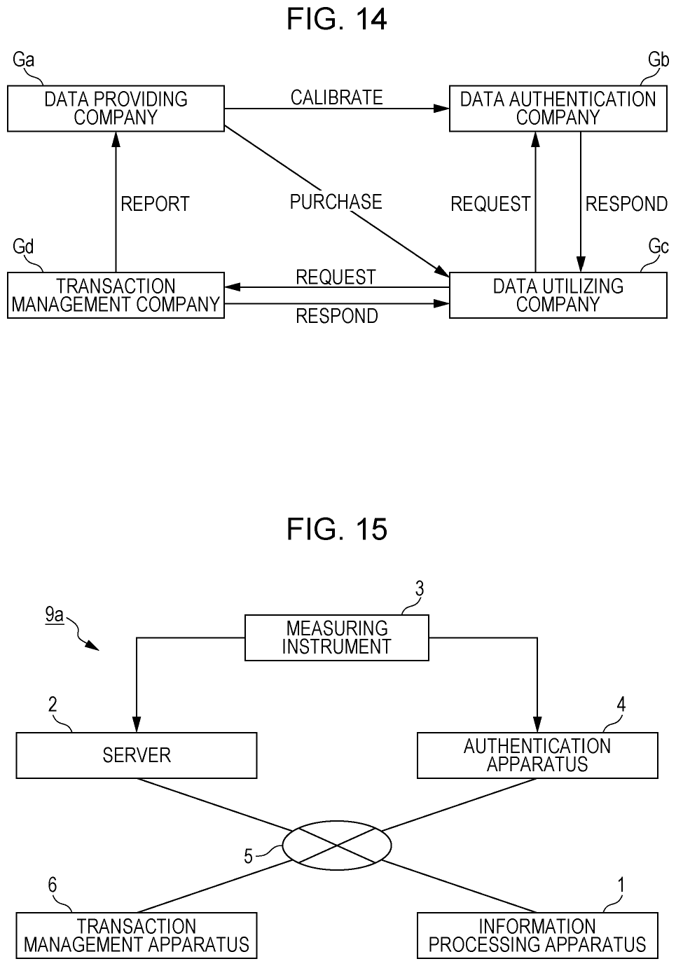

FIG. 14 is a diagram for describing exemplary organizations employing a modified example of the present disclosure. It is assumed that, in addition to the three organizations illustrated in FIG. 1, a transaction management company Gd employs the modified example of the present disclosure.

The transaction management company Gd is an organization which stores and manages information about transactions in which the data utilizing company Gc purchased data from the data providing company Ga. The transaction management company Gd provides information about past data transactions in response to a request from the data utilizing company Gc. The transaction management company Gd reports information about managed transactions to the data providing company Ga. The transaction management company Gd is remunerated for the provision of information to the data utilizing company Gc and the report to the data providing company Ga.

FIG. 15 is a diagram illustrating the configuration of a system 9a according to the modified example. The system 9a includes the information processing apparatus 1, the server 2, the measuring instruments 3, the authentication apparatus 4, and the communication line 5. The system 9a according to the modified example further includes a transaction management apparatus 6.

The transaction management apparatus 6 is owned, for example, by the transaction management company Gd. The transaction management apparatus 6, which is connected to the communication line 5, communicates with the information processing apparatus 1 and the server 2 through the communication line 5. The transaction management apparatus 6 is, for example, a computer.

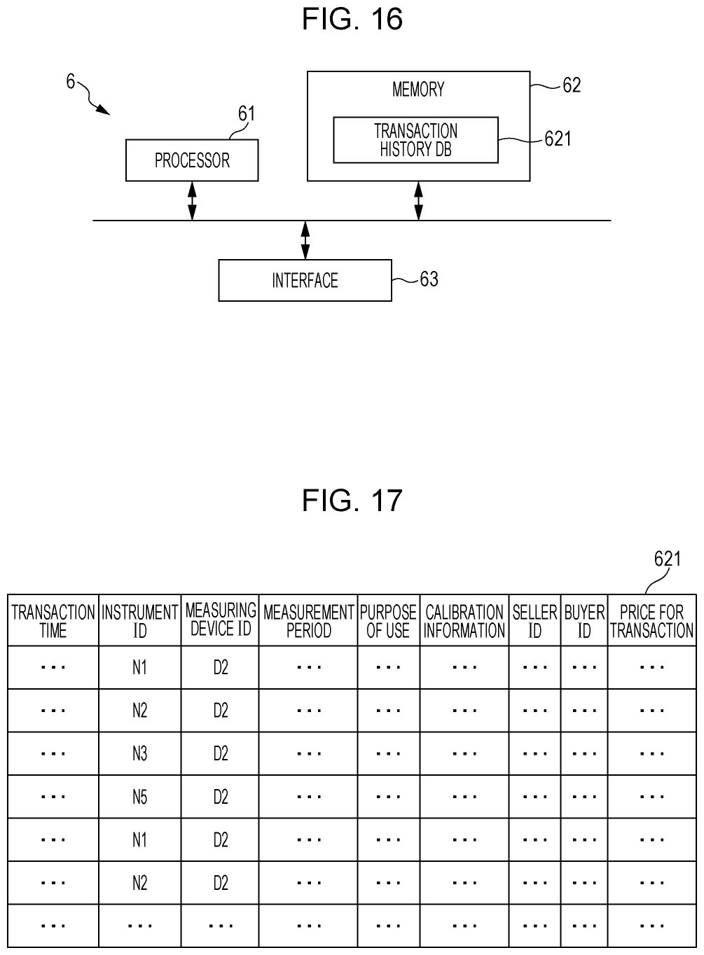

FIG. 16 is a diagram illustrating an exemplary configuration of the transaction management apparatus 6. The transaction management apparatus 6 illustrated in FIG. 16 includes a processor 61, a memory 62, and an interface 63. These configurations are connected to each other, for example, through a bus communicatively.

The processor 61 reads, for execution, programs stored in the memory 62, thus controlling the units of the transaction management apparatus 6. The processor 61 is, for example, a CPU.

The interface 63 is a communication line which connects the transaction management apparatus 6 to other apparatuses with or without wires communicatively. As illustrated in FIG. 15, the interface 63 illustrated in FIG. 16 communicates with the information processing apparatus 1 and the server 2 through the communication line 5.

The memory 62 is a storage unit which stores an operating system, which is read by the processor 61, various programs and data, and the like. The memory 62 includes a RAM and a ROM. The memory 62 may include a solid state drive and a hard disk drive. The memory 62 stores a transaction history DB 621.

FIG. 17 is a diagram illustrating an exemplary transaction history DB 621. The transaction history DB 621 stores a data transaction history. Examples of information stored in the transaction history DB 621 include identification information of data purchased by a user of the information processing apparatus 1, information about the calibration, which was applied to the data, and the price for purchase of the data.

The transaction history DB 621 illustrated in FIG. 17 has items of the transaction time, the instrument ID, the measuring device ID, the measurement period, the purpose of use, the calibration information, the seller ID, the buyer ID, and the price for transaction.

In the transaction history DB 621, the transaction time is information indicating the time at which the data purchase transaction was made. The measuring device ID is identification information of a measuring device 36 which measured the purchased data. The instrument ID is identification information of the measuring instrument 3 including the measuring device 36. The measurement period is information indicating the period from the start to the end of measurement of the data purchased by the user of the information processing apparatus 1. The purpose of use is information indicating the purpose of use of the purchased data. The calibration information is information about the calibration which was applied to the purchased data. The seller ID is identification information of the data providing company Ga which is the owner of the server 2 which sold the data. The buyer ID is identification information of the data utilizing company Gc which is the owner of the information processing apparatus 1 which purchased the data. The price for transaction is information indicating the amount payed for the purchased data.

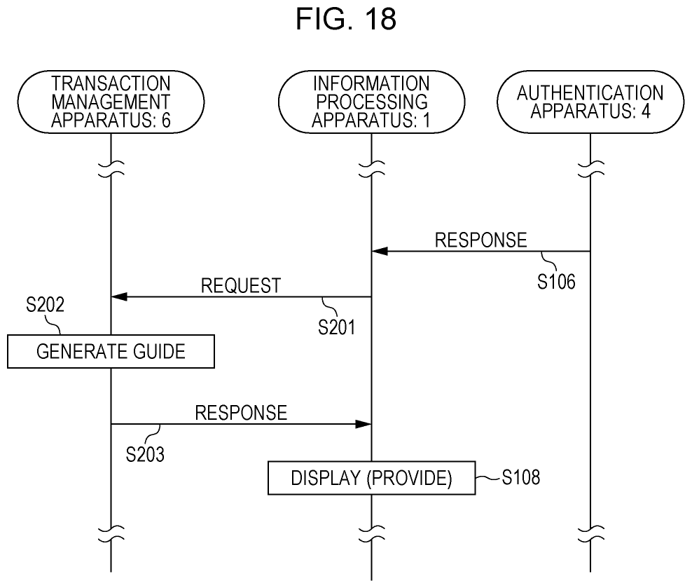

FIG. 18 is a sequence chart for describing the flow of operations of the information processing apparatus 1 according to the modified example. The operations of the information processing apparatus 1 and the like which are illustrated in FIG. 18 include, as common steps, steps S101 to S106 and steps S108 to S111 which are illustrated in FIG. 13. FIG. 18 does not illustrate these steps. Instead of step S107 illustrated in FIG. 13, the operations illustrated in FIG. 18 include step S201, S202, and S203.

As illustrated in FIG. 18, the authentication apparatus 4 transmits, to the information processing apparatus 1, information about each record of the calibration history extracted from the calibration history DB 421, and thus responds to the request from the information processing apparatus 1 (step S106). In response to this, the information processing apparatus 1 requests, from the transaction management apparatus 6, an evaluation, which is based on past transactions, of data to which calibration indicated by these obtained pieces of information was applied (step S201). This request includes the purpose of use which indicates for which purpose the user of the information processing apparatus 1 is to use the data that is to be purchased.

When the transaction management apparatus 6 receives the request from the information processing apparatus 1, the transaction management apparatus 6 refers to the transaction history DB 621 in accordance with the request. The transaction management apparatus 6 extracts, from the transaction history DB 621, past transactions which fulfil the user's purpose of use, compares the extracted data with the data specified in the request, and evaluates the specified data. This evaluation reflects, for example, information about the measuring devices 36 which measured the data which was purchased in the extracted transactions, the prices for transaction, the volumes of transaction, the transaction frequencies, and the like. The transaction management apparatus 6 generates a guide including the evaluation result (step S202), and transmits the generated guide as a response to the information processing apparatus 1 which is the request source, thus responding to the received request (step S203). Therefore, the guide which is generated and is transmitted as a response is an exemplary guide including the evaluation result obtained by evaluating the data on the basis of a transaction history of different data which was provided by the provision source which provides the data.

The information processing apparatus 1 displays, on the display unit 15, the guide, which is included in the response from the transaction management apparatus 6, in association with the data specified by the user, thus providing the guide to the user (step S108).

In this aspect, the information processing apparatus 1 provides, to a user, various types of information, such as data which was actually purchased for the user's purpose of use, the trend of data sales, the types and frequencies of calibration which was applied to popular data, and the prices of purchased data. Therefore, the user, who obtains these types of information, may select data, which is to be purchased, on the basis of these types of information.

<5>

In the present exemplary embodiment, the processor 11 generates a guide in accordance with information obtained from the authentication apparatus 4. Alternatively, in addition to the information about calibration which was applied to data, the processor 11 may generate a guide including information (referred to as content information) indicating the content of calibration that is to be applied to the data. For example, when the user of the information processing apparatus 1 specifies the purpose of use of data, the information processing apparatus 1 may generate a guide indicating the content of calibration necessary for the data to have the quality maintained in accordance with the specified purpose of use, on the basis of the relationship between predetermined purpose of use and data quality, thus providing the guide to the user. The data quality may be associated with the type and frequency of calibration, a device used in calibration, an examining authority which certificates calibration, and the like. In the modified example, the processor 11 is an exemplary processor which generates a guide including content information indicating the content of calibration that is to be applied to any piece of data.

The guide may be generated by the processor 61 of the transaction management apparatus 6 according to the modified example described above. In this case, the processor 61 may generate a guide, including the content of calibration which fulfils the purpose of use, on the basis of the past transaction history stored in the transaction history DB 621. In addition, the guide may be included in a report to the server 2. This enables the data providing company Ga, which operates the server 2, to know information about calibration employed in well-selling data, information about calibration necessary to increase the additional value of data provided by the data providing company Ga, or the like.

<6>

In the present exemplary embodiment, a program executed by the processor 11 of the information processing apparatus 1 is an exemplary program which causes a computer, which has a processor, to execute obtaining data, obtaining information about calibration which was applied to the data, and providing the data to a user in association with a guide obtained in accordance with the information about calibration on the data.

The program may be provided by storing the program in a computer-readable recording medium, for example, a magnetic recording medium, such as a magnetic tape or a magnetic disk, an optical recording medium such as an optical disk, a magneto-optical recording medium, or a semiconductor memory. The program may be downloaded through a communication line such as the Internet.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
obtain data,
obtain calibration information about calibration applied to the data, and
provide, to a user, the data in association with a guide which is obtained based on the calibration information or a pattern of the calibration information.

2. The information processing apparatus according to claim 1,
wherein the processor is configured to
obtain measurement time information in association with the data, the measurement time information indicating a time at which the data is measured, and
obtain, by using the measurement time information, the calibration information about the calibration on the data, the data being measured at the time indicated by the measurement time information.

3. The information processing apparatus according to claim 2,
wherein the processor is configured to
obtain the calibration information along with calibration time information, the calibration time information indicating a time at which the calibration is applied to the data, the calibration being indicated by the calibration information, and
provide any piece of the data in association with the guide by using the measurement time information and the calibration time information.

4. The information processing apparatus according to claim 1,
wherein the processor is configured to
obtain the calibration information from a provision source which provides the data, the calibration information being presented in a form different from a form of the data.

5. The information processing apparatus according to claim 1,
wherein the calibration indicated by the calibration information has at least two types, the two types including first calibration using a determined reference and second calibration using a relationship between measuring devices which are used in measurement of data, and
wherein the calibration information includes type information indicating a type of the calibration indicated by the calibration information.

6. The information processing apparatus according to claim 2,
wherein the calibration indicated by the calibration information has at least two types, the two types including first calibration using a determined reference and second calibration using a relationship between measuring devices which are used in measurement of data, and
wherein the calibration information includes type information indicating a type of the calibration indicated by the calibration information.

7. The information processing apparatus according to claim 3,
wherein the calibration indicated by the calibration information has at least two types, the two types including first calibration using a determined reference and second calibration using a relationship between measuring devices which are used in measurement of data, and
wherein the calibration information includes type information indicating a type of the calibration indicated by the calibration information.

8. The information processing apparatus according to claim 4,
wherein the calibration indicated by the calibration information has at least two types, the two types including first calibration using a determined reference and second calibration using a relationship between measuring devices which are used in measurement of data, and
wherein the calibration information includes type information indicating a type of the calibration indicated by the calibration information.

9. The information processing apparatus according to claim 5,
wherein the calibration information about the second calibration includes information generated in accordance with at least one of (a) an algorithm using the relationship, (b) count of the measuring devices, or (c) locations of the measuring devices.

10. The information processing apparatus according to claim 6,
wherein the calibration information about the second calibration includes information generated in accordance with at least one of (a) an algorithm using the relationship, (b) count of the measuring devices, or (c) locations of the measuring devices.

11. The information processing apparatus according to claim 7,
wherein the calibration information about the second calibration includes information generated in accordance with at least one of (a) an algorithm using the relationship, (b) count of the measuring devices, or (c) locations of the measuring devices.

12. The information processing apparatus according to claim 8,
wherein the calibration information about the second calibration includes information generated in accordance with at least one of (a) an algorithm using the relationship, (b) count of the measuring devices, or (c) locations of the measuring devices.

13. The information processing apparatus according to claim 1,
wherein the guide includes an evaluation result obtained by evaluating the data by using an evaluation method that is determined based on the calibration information.

14. The information processing apparatus according to claim 2,
wherein the guide includes an evaluation result obtained by evaluating the data by using an evaluation method that is determined based on the calibration information.

15. The information processing apparatus according to claim 3,
wherein the guide includes an evaluation result obtained by evaluating the data by using an evaluation method that is determined based on the calibration information.

16. The information processing apparatus according to claim 4,
wherein the guide includes an evaluation result obtained by evaluating the data by using an evaluation method that is determined based on the calibration information.

17. The information processing apparatus according to claim 5,
wherein the guide includes an evaluation result obtained by evaluating the data by using an evaluation method that is determined based on the calibration information.

18. The information processing apparatus according to claim 1,
wherein the guide includes an evaluation result obtained by evaluating the data on a basis of a transaction history of different data previously provided by a provision source, the provision source providing the data.

19. The information processing apparatus according to claim 1,
wherein the guide includes content information indicating content of calibration that is to be applied to any piece of the data,

20. A non-transitory computer readable medium storing a program causing a computer to execute a process, the computer having a processor, the process comprising:
obtaining data;
obtaining calibration information about calibration applied to the data; and
providing, to a user, the data in association with a guide which is obtained based on the calibration information or a pattern of the calibration information.
